(19) United States
(12) Patent Application Publication
(10) Pub. No.: US 2015/0188660 A1
(43) Pub. Date: Jul. 2, 2015

(54) APPARATUS AND METHOD FOR SIMULTANEOUSLY TRANSMITTING AND RECEIVING ORBITAL ANGULAR MOMENTUM (OAM) MODES

(71) Applicant: Electronics and Telecommunications Research Institute, Daejeon (KR)

(72) Inventors: Woo Jin BYUN, Daejeon (KR); Yong Heui CHO, Daejeon (KR); Kwang Seon KIM, Daejeon (KR); Bong Su KIM, Daejeon (KR); Min Soo KANG, Daejeon (KR); Jong Soo LIM, Daejeon (KR)

(73) Assignee: Electronics and Telecommunications Research Institute, Daejeon (KR)

(21) Appl. No.: 14/582,399

(22) Filed: Dec. 24, 2014

(30) Foreign Application Priority Data
Dec. 31, 2013 (KR) 10-2013-0168992

(51) Int. Cl. H04J 14/04

(52) U.S. Cl. CPC H04J 14/04

(57) ABSTRACT

Provided is an apparatus and method for simultaneously transmitting and receiving orbital angular momentum (OAM) modes. An apparatus for transmitting OAM modes may include a mode multiplexing apparatus, and a matrix array antenna configured to output OAM modes for electromagnetic waves based on mode signals, wherein the mode multiplexing apparatus may include hybrid couplers configured to generate a plurality of output signals having different phases and different amplitudes by mixing and distributing a plurality of input signals, and phase shifters configured to generate the mode signals by shifting the phases of the output signals.

### CROSS-REFERENCE TO RELATED APPLICATION

This application claims the benefit of Korean Patent Application No. 10-2013-0168992, filed on Dec. 31, 2013, in the Korean Intellectual Property Office, the disclosure of which is incorporated herein by reference.

### BACKGROUND

1. Field of the Invention

Embodiments of the present invention relate to an apparatus and method for simultaneously transmitting and receiving orbital angular momentum (OAM) modes, and more particularly, to an apparatus and method that may restore an input signal by simultaneously transmitting or receiving electromagnetic wave signals having OAM modes through a matrix array antenna.

2. Description of the Related Art

An orbital angular momentum (OAM) relates to a technique that transmits or receives an electromagnetic wave using an electromagnetic wave mode, and is used for a waveguide or a transmission line. Electromagnetic wave modes may be orthogonal to each other and independently transmit electromagnetic wave power. Thus, when the OAM technique is applied to wireless communications, independent communication channels with different and distinct OAM modes may be configured.

A communication system to which an existing OAM technique is applied is an optical communication system. A transmitting apparatus of the communication system may split a laser beam into a plurality of beams using a beam splitter, and generate different OAM modes by applying a lens or hologram that generates predetermined OAM modes to the respective split beam. The transmitting apparatus may multiplex the OAM modes by combining the OAM mode-generated beams using a beam combiner.

However, when the OAM technique is applied to an invisible wireless communication system using an electromagnetic wave, a structure of the optical communication system may be unusable. Dissimilar to laser beams used for optical communication, it is difficult to concentrate electronic waves used for wireless communication on a narrow area with high density. Thus, manufacturing of a super high frequency apparatus that operates as the beam splitter and the beam combiner may be difficult.

Accordingly, a method of simultaneously transmitting or receiving different OAM modes by applying an OAM technique to an invisible wireless communication system using an electromagnetic wave is demanded.

### SUMMARY

An aspect of the present invention provides an apparatus and method that may simultaneously transmit or receive different orbital angular momentum (OAM) modes for electromagnetic waves, the OAM modes acting as independent communication channels in OAM mode communication for an invisible electromagnetic wave band.

According to an aspect of the present invention, there is provided an apparatus for transmitting OAM modes, the apparatus including a mode multiplexing apparatus, and a matrix array antenna configured to output OAM modes for electromagnetic waves based on mode signals. The mode multiplexing apparatus may include hybrid couplers configured to generate a plurality of output signals having different phases and different amplitudes by mixing and distributing a plurality of input signals, and phase shifters configured to generate the mode signals by shifting the phases of the output signals.

The phases and the amplitudes of the output signals may be determined based on scattering matrices of the hybrid couplers.

The mode multiplexing apparatus may include layers disposed in a hierarchical structure, the layers respectively including at least one hybrid coupler and at least one phase shifter.

Phases and amplitudes of the mode signals may be determined based on a phase shift value of the at least one phase shifter and a connection structure among the at least one hybrid coupler in each layer.

The matrix array antenna may include a plurality of element antennas corresponding to the respective mode signals and arranged in a form of a two-dimensional (2D) matrix.

The mode multiplexing apparatus may be configured to respectively transmit the mode signals to the element antennas using transmission lines corresponding to the element antennas.

According to an aspect of the present invention, there is provided an apparatus for receiving OAM modes, the apparatus including a matrix array antenna configured to output mode signals excited based on OAM modes for electromagnetic waves, and a mode demultiplexing apparatus configured to restore input signals by mixing the mode signals, distributing the mode signals, and shifting phases of the mode signals.

The mode demultiplexing apparatus may include at least one hybrid coupler configured to generate a plurality of output signals having different phases and different amplitudes by mixing and distributing the plurality of mode signals received from the matrix array antenna, and at least one phase shifter configured to restore the input signals by shifting the phases of the output signals.

The matrix array antenna may include a plurality of small antennas corresponding to the respective OAM modes for electromagnetic waves and arranged in a form of a 2D matrix.

According to an aspect of the present invention, there is provided a method of transmitting OAM modes, the method including generating mode signals by mixing a plurality of input signals, distributing the plurality of input signals, and shifting phases of the plurality of input signals using a mode multiplexing apparatus, and outputting OAM modes for electromagnetic waves using a matrix array antenna based on the mode signals.

According to an aspect of the present invention, there is provided a method of receiving OAM modes, the method including outputting mode signals excited based on OAM modes for electromagnetic waves using a matrix array antenna, and restoring input signals by mixing the mode signals, distributing the mode signals, and shifting phases of the mode signals using a mode demultiplexing apparatus.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for transmitting orbital angular momentum (OAM) modes according to an embodiment of the present invention;

FIG. 2 is a diagram illustrating an operation of an apparatus for transmitting OAM modes according to an embodiment of the present invention;

FIG. 3 is a diagram illustrating a mode multiplexing apparatus according to an embodiment of the present invention;

FIG. 4 is a diagram illustrating a matrix array antenna according to an embodiment of the present invention;

FIG. 5 is a diagram illustrating a reflecting plate antenna according to an embodiment of the present invention;

FIG. 6 is a block diagram illustrating an apparatus for receiving OAM modes according to an embodiment of the present invention;

FIG. 7 is a diagram illustrating an operation of an apparatus for receiving OAM modes according to an embodiment of the present invention;

FIG. 8 is a graph illustrating a result of generating a mode signal using a mode multiplexing apparatus according to an embodiment of the present invention;

FIG. 9 is a flowchart illustrating a method of transmitting OAM modes according to an embodiment of the present invention; and

FIG. 10 is a flowchart illustrating a method of receiving OAM modes according to an embodiment of the present invention.

### DETAILED DESCRIPTION

Hereinafter, embodiments of the present invention will be described in detail with reference to the accompanying drawings. A method of transmitting orbital angular momentum (OAM) modes and a method of receiving OAM mode according to an embodiment of the present invention may be performed by an apparatus for transmitting OAM modes and an apparatus for receiving OAM modes, respectively.

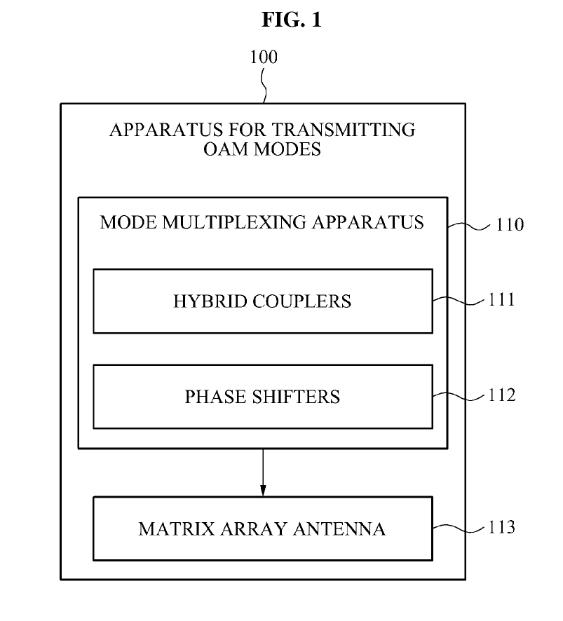

FIG. 1 is a block diagram illustrating an apparatus 100 for transmitting OAM modes according to an embodiment of the present invention.

Referring to FIG. 1, the apparatus 100 for transmitting OAM modes includes a mode multiplexing apparatus 110 and a matrix array antenna 120.

The mode multiplexing apparatus 110 may generate a plurality of mode signals based on a plurality of input signals.

The mode signals may be signals input into the matrix array antenna 120 to enable the matrix array antenna 120 to output OAM modes for electromagnetic waves. A number of the input signals may correspond to a number of the mode signals. A single OAM mode may correspond to a single communication channel. Thus, the number of the input signals input into the mode multiplexing apparatus 110 may be equal to the number of the mode signals output by the mode multiplexing apparatus 110.

The mode multiplexing apparatus 110 may output K mode signals by mixing and distributing K input signals, thereby forming K independent communication channels. By forming the K independent communication channels, the mode multiplexing apparatus 110 may expand a communication channel capacity having an identical frequency and polarization characteristic by a factor of K.

The mode multiplexing apparatus 110 includes hybrid couplers 111 and phase shifters 112.

The hybrid couplers 111 may generate a plurality of output signals having different phases and different amplitudes by mixing and distributing a plurality of input signals.

The phases and the amplitudes of the output signals may be determined based on scattering matrices of the hybrid couplers 111.

The hybrid couplers 111 may be configured using active devices or passive devices. For example, a hybrid coupler 111 implemented using a passive device may include a branch-line hybrid coupler, a ring hybrid coupler, and a magic tee coupler.

The phase shifters 112 may generate the mode signals by shifting the phases of the output signals generated by the hybrid couplers 111.

The phase shifters 112 may generate the mode signals by shifting the phases of the output signals to predetermined phases and outputting the phase-shifted output signals. The phase shifters 112 may be implemented using active devices or passive devices.

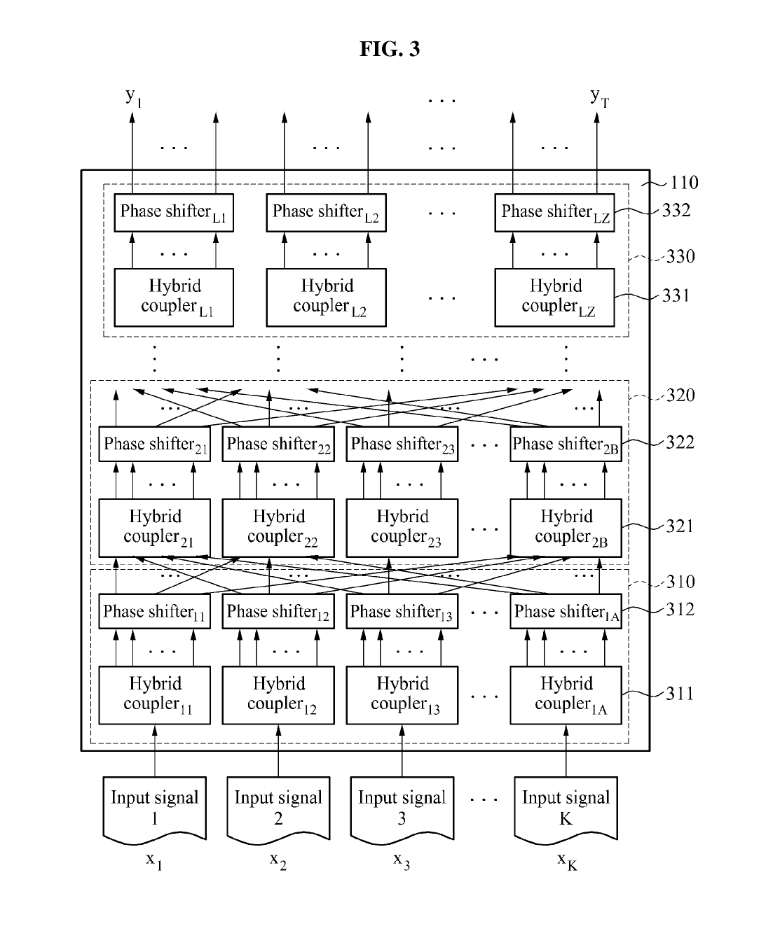

The mode multiplexing apparatus 110 may include layers disposed in a hierarchical structure. The layers may respectively include at least one hybrid coupler 111 and at least one phase shifter 112. A configuration and an operation of the mode multiplexing apparatus 110 will be described in detail with reference to FIG. 3.

The mode signals generated by the mode multiplexing apparatus 110 may be determined based on characteristics of the hybrid couplers 111 and the phase shifters 112 included in the mode multiplexing apparatus 110, as given by Equation 1.

$$[ \begin{matrix}{y}_{1} \\ {y}_{2} \\ ⋮ \\ {y}_{T}\end{matrix} ] = S [ \begin{matrix}{x}_{1} \\ {x}_{2} \\ ⋮ \\ {x}_{K}\end{matrix} ] \qquad [ Equation 1 ]$$

In Equation 1, x₁, x₂, . . . , xₖ denote signals input into the mode multiplexing apparatus 110. S denotes an input-output matrix of the mode multiplexing apparatus 110, and may be determined based on input-output matrices of the hybrid couplers 111 and the phase shifters 112 of each layer.

In detail, each element Sᵢₖ of the denotes an input-output matrix S may be determined based on wiring per layer of the hybrid couplers 111 and phase shift values of the phase shifters 112.

A relationship between each element Sᵢₖ of the matrix S and an input signal may be expressed by a simple simultaneous equation, as given by Equation 2.

$$\begin{matrix}{y}_{i}^{( 1 )} & = & {S}_{i 1} {x}_{1} \\ {y}_{i}^{( 2 )} & = & {S}_{i 2} {x}_{2} \\ ⋮ & & ⋮ \\ {y}_{i}^{( K )} & = & {S}_{i K} {x}_{K}\end{matrix} \qquad [ Equation 2 ]$$

In Equation 2, i=1, 2, . . . , [symbol] may be satisfied, and yᵢ^{(k)} denotes an amplitude and a phase of an i-th output signal when value of all remaining input signals, except for value of a k-th input signal, are equal to “0”.

When a number of an OAM mode to be used as a communication channel is selected, input amplitudes and phases of mode signals to be input into the matrix array antenna 120 may be subordinately determined. Thus, the amplitude and the phase of the i-th output signal may be determined based on an OAM mode output by an i-th element antenna of the matrix array antenna 120. In addition, since an input signal xₖ also corresponds to determined information, Sᵢₖ may be determined by substituting yᵢ^{(k)} and xₖ corresponding to the OAM mode to Equation 2. The hierarchical structure among layers respectively including the hybrid couplers 111 and the phase shifters 112 in the mode multiplexing apparatus 110 may be designed based on the determined Sᵢₖ.

The matrix array antenna 120 may output OAM modes for electromagnetic waves based on the mode signals generated by the mode multiplexing apparatus 110. The OAM modes for electromagnetic waves may be electromagnetic wave signals having OAM modes.

The matrix array antenna 120 may include a plurality of element antennas corresponding to the mode signals and arranged in a form of a two-dimensional (2D) matrix. A number of the element antennas may correspond to a number of the mode signals and a number of the OAM modes for electromagnetic waves.

The matrix array antenna 120 may be connected to the mode multiplexing apparatus 110 via transmission lines corresponding to the respective element antennas. For example, when the matrix array antenna 120 is arranged in a form of a 2D matrix having M rows and N columns, a number T of the transmission lines may correspond to M×N. The mode multiplexing apparatus 110 may transmit the mode signals to the element antennas via the transmission lines connected to the respective element antennas.

The matrix array antenna 120 may be used as a matrix feed configured to output the OAM modes for electromagnetic waves toward a reflecting plate antenna.

The apparatus 100 for transmitting OAM modes may generate a plurality of mode signals having different amplitudes and different phases by multiplexing input signals, and output different OAM modes for electromagnetic waves based on the mode signals using a matrix array antenna, thereby simultaneously transmitting the different OAM modes for electromagnetic waves, the OAM modes acting as independent communication channels in OAM mode communication for an invisible electromagnetic wave band.

In addition, the OAM modes may be orthogonal to each other. Thus, although an OAM mode for an electromagnetic wave and another OAM mode for an electromagnetic wave use an identical frequency and polarization, the OAM mode may be distinct from the other OAM mode. An apparatus for receiving OAM modes may distinguish a plurality of OAM modes for electromagnetic waves using an identical frequency and polarization, among the OAM modes for electromagnetic waves output by the apparatus 100 for transmitting OAM modes. Thus, by implementing transmission and reception multiplexing of wireless communication, a frequency usage efficiency in a super high frequency band may increase.

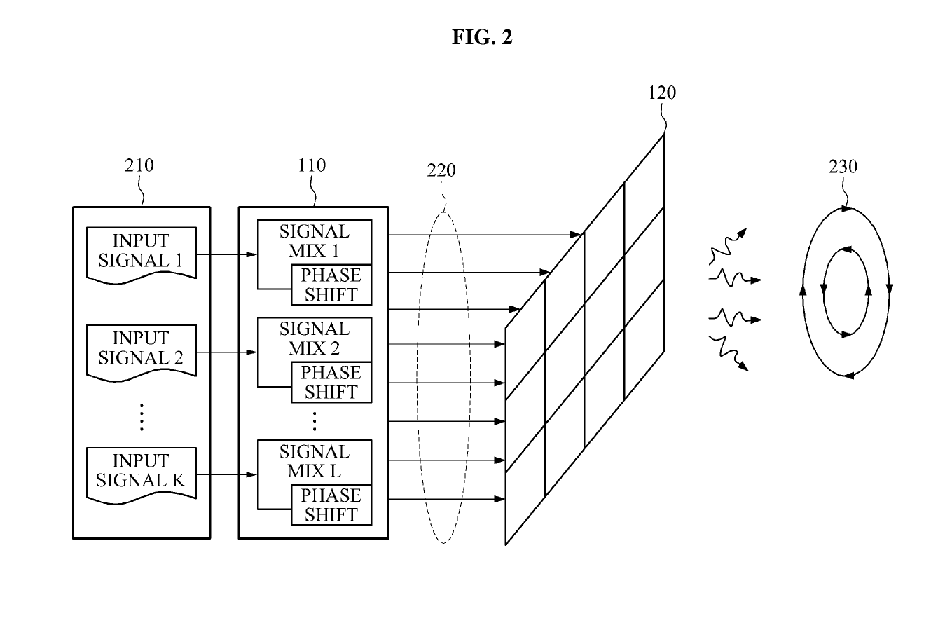

FIG. 2 is a diagram illustrating an operation of an apparatus for transmitting OAM modes according to an embodiment of the present invention.

Referring to FIG. 2, the mode multiplexing apparatus 110 of the apparatus for transmitting OAM modes receives a plurality of input signals 210. The mode multiplexing apparatus 110 distributes and mixes the input signals 210 using the hybrid couplers 111. In addition, the mode multiplexing apparatus 110 outputs mode signals by shifting phases of the mixed signals using the phase shifters 112.

The mode signals are transmitted to element antennas of the matrix array antenna 120 via transmission lines 220 corresponding to the respective element antennas.

The element antennas of the matrix array antenna 120 output OAM modes 230 for electromagnetic waves based on the received mode signals in a space.

FIG. 3 is a diagram illustrating the mode multiplexing apparatus 110 according to an embodiment of the present invention.

Referring to FIG. 3, the mode multiplexing apparatus 110 includes a first layer 310, a second layer 320, . . . , and an L-th layer 330 disposed in a hierarchical structure. The first layer 310, the second layer 320, . . . , and the L-th layer 330 respectively include hybrid couplers and phase shifters.

Hybrid couplers 311 of the first layer 310 may respectively receive an input signal. The hybrid couplers 311 may respectively distribute the received input signal into a plurality of first output signals, and transmit the first output signals to phase shifters 312 of the first layer 310.

The phase shifters 312 of the first layer 310 may respectively change the received first output signals to first phase-shifted signals by shifting phases of the received first output signals. The phase shifters 312 may respectively transmit the first phase-shifted signals to hybrid couplers 321 of the second layer 320. The phase shifters 312 may respectively transmit the plurality of first phase-shifted signals to different hybrid couplers 321. For example, a phase shifter11 transmits first phase-shifted signals to a hybrid coupler₂₁, a hybrid coupler₂₂, and a hybrid coupler_{2B}.

The hybrid couplers 321 of the second layer 320 may respectively mix received first phase-shifted signals, distribute the mixed first phase-shifted signals into a plurality of second output signals, and transmit the second output signals to phase shifters 322 of the second layer 320. The hybrid couplers 321 may respectively receive different first phase-shifted signals from the plurality of phase shifters 312, and mix the received first phase-shifted signals. For example, the hybrid coupler₂₁ receives first phase-shifted signals, obtained by shifting phases of an input signal 1, an input signal 2, an input signal 3, . . . , and an input signal K, from the phase shifter₁₁, a phase shifter₁₂, a phase shifter₁₃, . . . , and a phase shifter_{1A}, respectively. The hybrid coupler₂₁ mixes and distributes the received first phase-shifted signals. In detail, the hybrid coupler₂₁ mixes and distributes the phase-shifted input signal 1, the phase-shifted input signal 2, the phase-shifted input signal 3, . . . , and the phase-shifted input signal K into a plurality of second output signals, and transmits the second output signals to a phase shifter₂₁.

The phase shifters 322 of the second layer 320 may respectively change the received second output signals to second phase-shifted signals by shifting phases of the received second output signals. The phase shifters 322 may respectively transmit the second phase-shifted signals to hybrid couplers of a third layer.

The foregoing process may be iteratively performed to the last layer, that is, the L-th layer 330.

Hybrid couplers 331 of the L-th layer 330 may respectively mix received phase-shifted signals, distribute the mixed phase-shifted signals into a plurality of L-th output signals, and transmit the L-th output signals to phase shifters 332 of the L-th layer 330. The phase shifters 332 of the L-th layer 330 may respectively output mode signals y₁, y₂, . . . , y₂ by shifting phases of the received L-th output signals.

The mode signals y₁, y₂, . . . , y₂ may be transmitted to element antennas of the matrix array antenna 120 via transmission lines.

The first layer 310, the second layer 320, . . . , and the L-th layer 330 may include different numbers of hybrid couplers and different numbers of phase shifters. For example, the first layer 310 may include A hybrid couplers and A phase shifters, the second layer 320 may include B hybrid couplers and B phase shifters, and the L-th layer 330 may include T hybrid couplers and T phase shifters. In this example, A, B, and T may be equal to or different from one another.

A number of output signals distributed by a hybrid coupler may correspond to a number of hybrid couplers of a subsequent layer. For example, a hybrid coupler 311 of the first layer 310 may distribute an input signal into B first output signals. A hybrid coupler 321 of the second layer 320 may mix first phase-shifted signals, and distribute the mixed first phase-shifted signals based on a number of the hybrid couplers of the third layer.

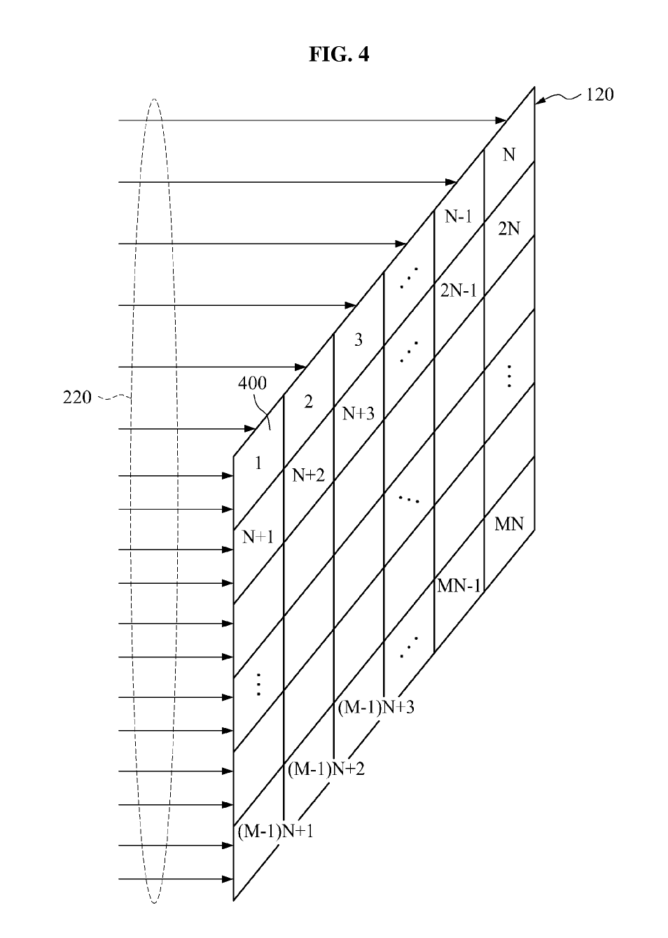

FIG. 4 is a diagram illustrating the matrix array antenna 120 according to an embodiment of the present invention.

Referring to FIG. 4, the matrix array antenna 120 includes a plurality of element antennas 400. The element antennas 400 may be implemented using active devices or passive devices. For example, an element antenna 400 implemented using a passive device may include a dipole antenna, a horn antenna, and a microstrip patch antenna. The element antennas 400 may be connected to the mode multiplexing apparatus 110 via the transmission lines 220. The element antennas 400 may receive mode signals via the transmission lines 220.

The matrix array antenna 120 may be configured by arranging the plurality of element antennas 400 in a form of a 2D matrix including M rows and N columns, as shown in FIG. 4. An element antenna number i marked in an element antenna 400 may be defined using Equation 3.

i=N·(m−1)+n[Equation 3]

In Equation 3, the element antenna number i may be identical to an output signal number i of Equation 2.

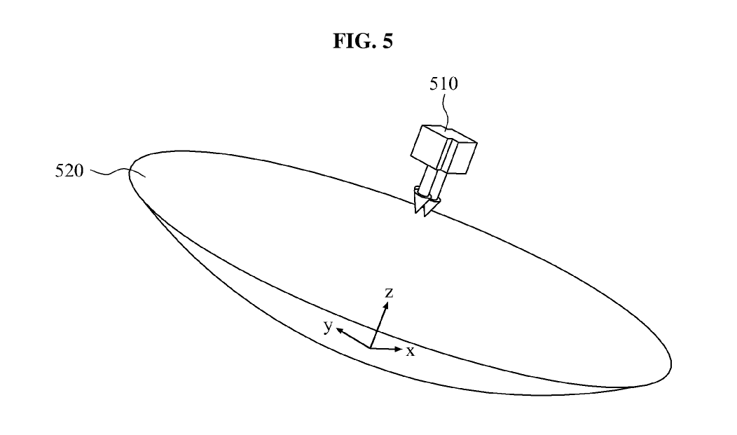

FIG. 5 is a diagram illustrating a reflecting plate antenna according to an embodiment of the present invention.

Referring to FIG. 5, the reflecting plate antenna includes a matrix feed 510 and a reflecting plate 520. The reflecting plate 520 may include, for example, a parabolic reflecting plate, and a reflect array antenna.

The matrix feed 510 may be configured similar to the matrix array antenna 120. The matrix feed 510 may output OAM modes for electromagnetic waves toward the reflecting plate 520 based on modes signals generated by the mode multiplexing apparatus 110.

The reflecting plate antenna may simultaneously generate OAM modes having high-gain characteristics using a relatively few number of matrix feeds, and transmit or receive the OAM modes.

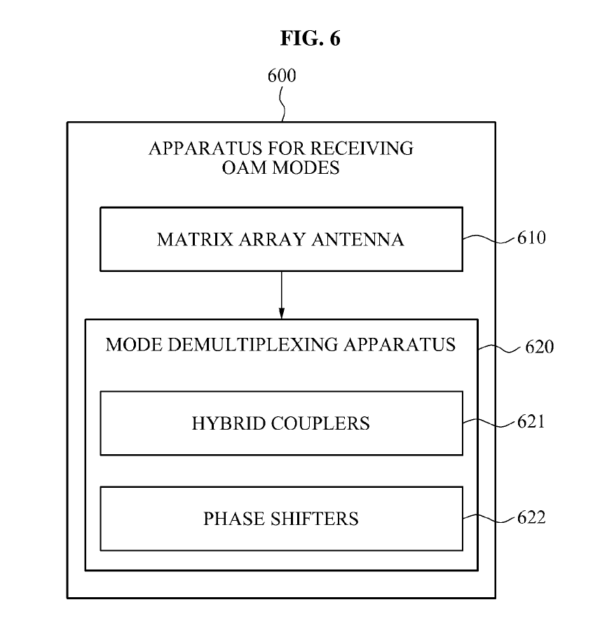

FIG. 6 is a block diagram illustrating an apparatus 600 for receiving OAM modes according to an embodiment of the present invention.

Referring to FIG. 6, the apparatus 600 for receiving OAM modes includes a matrix array antenna 610 and a mode demultiplexing apparatus 620.

The matrix array antenna 610 may receive a plurality of OAM modes for electromagnetic waves output by the matrix array antenna 120 of the apparatus 100 for transmitting OAM modes. The matrix array antenna 610 may include a plurality of antennas corresponding to the respective OAM modes for electromagnetic waves and arranged in a form of a 2D matrix.

Mode signals having different amplitudes and different phases may be excited for each element antenna of the matrix array antenna 610 based on the OAM modes for electromagnetic waves received by the matrix array antenna 610. The matrix array antenna 610 may output the excited mode signals to the mode demultiplexing apparatus 620. The matrix array antenna 610 may output the mode signals to the mode demultiplexing apparatus 620 via transmission lines connected to the respective element antennas.

When the matrix array antenna 120 and the matrix array antenna 610 are configured only using passive devices, the matrix array antenna 120 and the matrix array antenna 610 may have identical structures. Accordingly, FIG. 4 may also illustrate a configuration of the matrix array antenna 610.

The mode demultiplexing apparatus 620 may restore input signals by mixing the mode signals received from the matrix array antenna 610, distributing the mode signals, and shifting phases of the mode signals.

The mode demultiplexing apparatus 620 includes hybrid couplers 621 and phase shifters 622.

The hybrid couplers 621 may generate a plurality of output signals having different phases and different amplitudes by mixing and distributing the plurality of mode signals.

The phases and the amplitudes of the output signals may be determined based on scattering matrices of the hybrid couplers 621.

The hybrid couplers 621 may be configured using active devices or passive devices. For example, a hybrid coupler 621 implemented using a passive device may include a branch-line hybrid coupler, a ring hybrid coupler, and a magic tee coupler.

The phase shifters 622 may restore the input signals by shifting the phases of the output signals generated by the hybrid couplers 621.

The phase shifters 622 may restore the input signals by shifting the phases of the output signals to predetermined phases and outputting the phase-shifted output signals. The phase shifters 622 may be implemented using active devices or passive devices.

The mode demultiplexing apparatus 620 may include layers disposed in a hierarchical structure. The layers may respectively include at least one hybrid coupler 621 and at least one phase shifter 622. Similar to the mode multiplexing apparatus 110, the hierarchical structure among layers in the mode demultiplexing apparatus 620 may be designed based on Equations 1 and 2.

An input-output matrix of the mode demultiplexing apparatus 620 may be determined based on Equation 1. Since an amplitude and a phase of a mode signal corresponding to a predetermined OAM mode are fixed, an element Sᵢₖ of the input-output matrix of the mode demultiplexing apparatus 620 may be determined based on Equation 2. The hierarchical structure among layers may be designed based on the determined Sᵢₖ.

For example, when the mode multiplexing apparatus 110 and the mode demultiplexing apparatus 620 are configured only using passive devices, a reversibility of input and output may be valid. Thus, the matrix multiplexing apparatus 110 and the mode demultiplexing apparatus 620 may have identical structures. Accordingly, FIG. 3 may also illustrate a configuration of the mode demultiplexing apparatus 620.

When the matrix array antenna 610 and the mode demultiplexing apparatus 620 are configured using passive devices, the apparatus 600 for receiving OAM modes including the matrix array antenna 610 and the mode demultiplexing apparatus 620 may also be used as the apparatus 100 for transmitting OAM modes.

The OAM modes may be orthogonal to each other. Thus, the mode multiplexing apparatus 110 or the mode demultiplexing apparatus 620 may simultaneously generate mode signals based on input signals, and restore input signals based on mode signals.

When the mode multiplexing apparatus 100 or the mode demultiplexing apparatus 620 has a structure as shown in FIG. 3, an input signal to be transmitted may be input as the input signal 1 into a hybrid coupler11, and a mode signal received by the matrix array antenna 610 may be input as the input signal K into a hybrid coupler_{1A}.

Since the OAM modes are orthogonal to each other, the mode multiplexing apparatus 100 or the mode demultiplexing apparatus 620 may operate as a transmission-reception (Tx-Rx) duplex that simultaneously generates mode signals based on input signals and restores input signals based on mode signals.

However, a Tx-Rx separation of the Tx-Rx duplex using OAM modes may be significantly affected by separation characteristics among ports of hybrid couplers included in the first layer 310, the second layer 320, . . . , and the L-th layer 330. Thus, when the mode multiplexing apparatus 110 or the mode demultiplexing apparatus 620 is used as the Tx-Rx duplex, the structure of the mode multiplexing apparatus 110 or the mode demultiplexing apparatus 620 may be designed to achieve a separation among ports of hybrid couplers included in the first layer 310, the second layer 320, . . . , and the L-th layer 330 being greater than or equal to a threshold value.

The apparatus 600 for receiving OAM modes may restore the input signals separated for each OAM mode for an electromagnetic wave by demultiplexing the mode signals corresponding to the received OAM modes for electromagnetic waves. The apparatus 600 for receiving OAM modes may distinguish a plurality of signals using an identical frequency and polarization based on the orthogonal characteristic of the OAM modes. Thus, by implementing transmission and reception multiplexing of wireless communication, a frequency usage efficiency in a super high frequency band may increase.

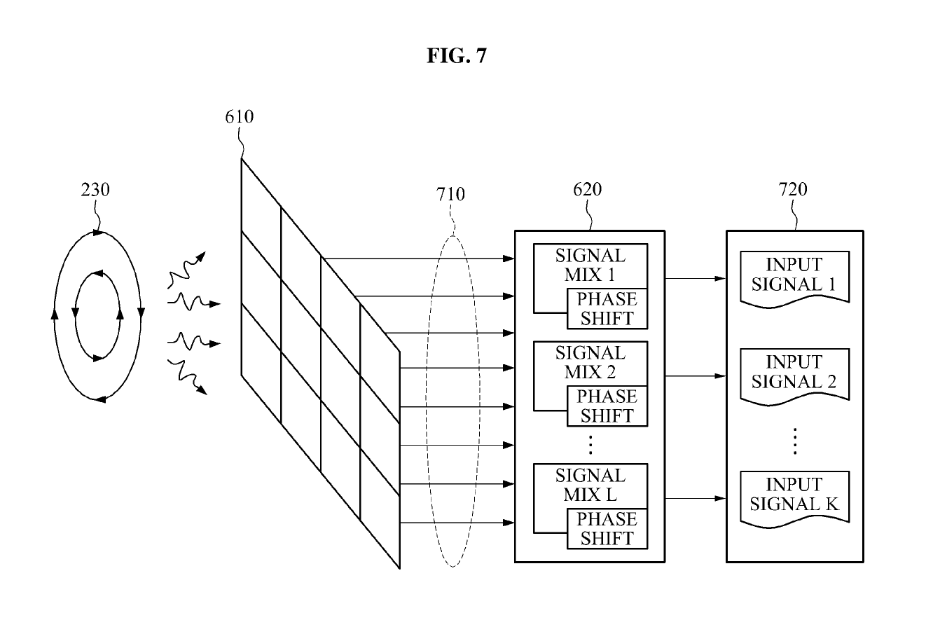

FIG. 7 is a diagram illustrating an operation of an apparatus for receiving OAM modes according to an embodiment of the present invention.

Referring to FIG. 7, element antennas of the matrix array antenna 610 receive the OAM modes 230 for electromagnetic waves output by the matrix array antenna 120.

Mode signals having different amplitudes and different phases are excited for each element antenna based on the OAM modes 230 for electromagnetic waves received by the element antennas of the matrix array antenna 610. The matrix array antenna 610 outputs the excited mode signals to the mode demultiplexing apparatus 620 via transmission lines 710 corresponding to the respective element antennas.

The mode demultiplexing apparatus 620 of the apparatus for receiving OAM modes distributes and mixes the mode signals received via the transmission lines 710. The mode demultiplexing apparatus 620 also restores input signals 720 independently separated from each other by shifting phases of the signals mixed by the phase shifters 622.

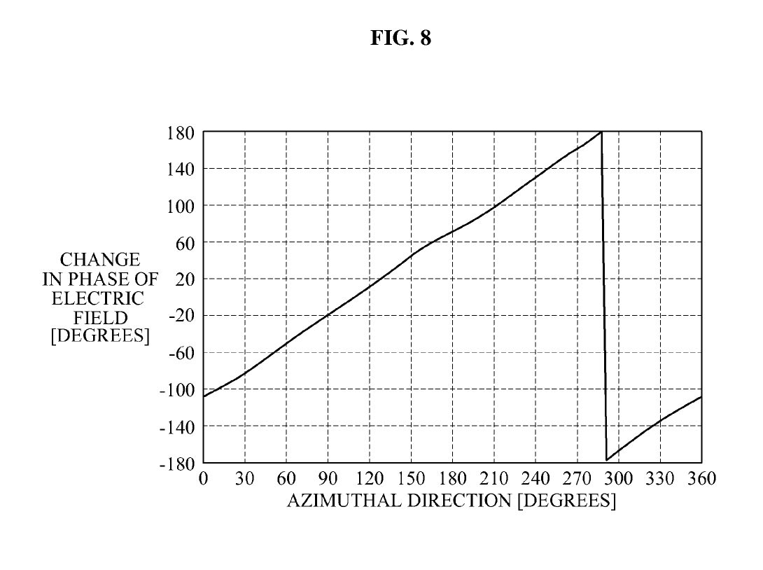

FIG. 8 is a graph illustrating a result of generating a mode signal using the mode multiplexing apparatus 110 according to an embodiment of the present invention.

FIG. 8 illustrates an example of a numerical analysis on a result of generating an OAM mode #1 using a 2×2 matrix array multiplexing apparatus.

The matrix array antenna 120 may be configured using 2×2 horn antennas, and used as the matrix feed 510 of the reflecting plate antenna of FIG. 5. The reflecting plate 520 may be a parabolic reflecting plate, and the matrix feed 510 may be disposed at a focal point of a parabola. The mode multiplexing apparatus 110 may be configured as illustrated in FIG. 3.

When the mode multiplexing apparatus 110 inputs a mode signal corresponding to the OAM mode #1 for an electromagnetic wave into the matrix array antenna 120, the reflecting plate antenna including the matrix feed 510 may output the OAM mode #1 for an electromagnetic wave.

Through a relationship between an azimuthal direction and a change in a phase of an electric field as shown in FIG. 8, it may be verified that the reflecting plate antenna has output the OAM mode #1 for an electromagnetic wave.

When the OAM mode #1 is output, the phase of the electric field may change linearly to the azimuthal direction. When an azimuth changes from 0 degrees to 360 degrees after the OAM mode #1 is output, the phase of the electric field may also change from 0 degrees to 360 degrees.

When the phase of the electric field changes linearly based on the azimuthal direction, and the azimuth changes from 0 degrees to 360 degrees, the phase of the electric field may also change from 0 degrees to 360 degrees. Thus, it may be determined that the reflecting plate antenna has output the OAM mode #1 for an electromagnetic wave.

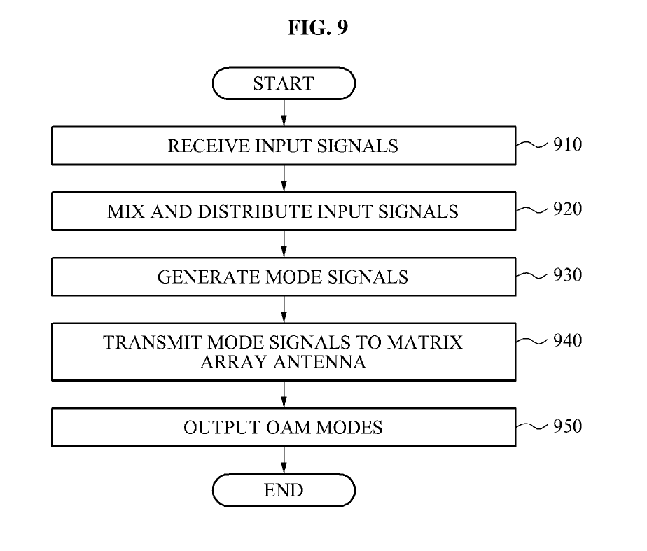

FIG. 9 is a flowchart illustrating a method of transmitting OAM modes according to an embodiment of the present invention.

Referring to FIG. 9, in operation 910, the mode multiplexing apparatus 110 receives input signals to be transmitted. In this example, hybrid couplers included in a first layer of the mode multiplexing apparatus 110 may respectively distribute a received input signal into a plurality of first output signals, and phase shifters included in the first layer may respectively shift phases of the first output signals and transmit the phase-shifted first output signals to hybrid couplers of a second layer.

In operation 920, the hybrid couplers 111 of the mode multiplexing apparatus 110 generate a plurality of output signals having different phases and different amplitudes by mixing and distributing the input signals received in operation 910.

In operation 930, the phase shifters 112 of the mode multiplexing apparatus 110 generate mode signals by shifting the phases of the output signals generated in operation 920.

When layers respectively including at least one hybrid coupler and at least one phase shifter are disposed in a hierarchical structure in the mode multiplexing apparatus 110, hybrid couplers and phase shifters included in the second layer through the last layer may perform operations 920 and 930.

In operation 940, the mode multiplexing apparatus 110 transmits the mode signals generated in operation 930 to the element antennas of the matrix array antenna 120 via the transmission lines 220. The transmission lines 220 may be a plurality of transmission lines corresponding to the respective element antennas.

In operation 950, the element antennas of the matrix array antenna 120 outputs OAM modes for electromagnetic waves based on the mode signals received in operation 940.

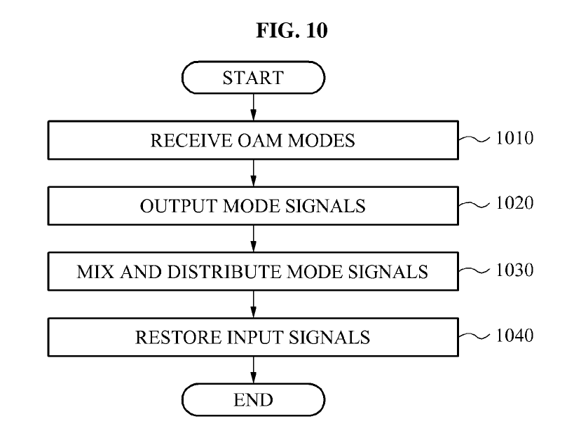

FIG. 10 is a flowchart illustrating a method of receiving OAM modes according to an embodiment of the present invention.

Referring to FIG. 10, in operation 1010, the element antennas of the matrix array antenna 610 receive OAM modes for electromagnetic waves output by the matrix array antenna 120.

Mode signals having different amplitudes and different phases may be excited for each element antenna based on the OAM modes for electromagnetic waves received by the element antennas of the matrix array antenna 610.

In operation 1020, the matrix array antenna 610 outputs the mode signals excited in operation 1010 to the mode demultiplexing apparatus 620 via the transmission lines 710 corresponding to the respective element antennas.

In operation 1030, the hybrid couplers 621 of the mode demultiplexing apparatus 620 generate output signals by distributing and mixing the mode signals received in operation 1020.

In operation 1040, the phase shifters 622 of the mode demultiplexing apparatus 620 restore input signals independently separated from each other by shifting phases of the output signals generated in operation 1030.

According to an aspect of the present invention, mode signals having different amplitudes and different phases may be generated by multiplexing input signals, and different OAM modes for electromagnetic waves may be output based on the mode signals using a matrix array antenna, whereby the different OAM modes acting as independent communication channels in OAM mode communication for an invisible electromagnetic wave band may be simultaneously transmitted. In addition, the input signals may be restored by demultiplexing the mode signals corresponding to the received OAM modes for electromagnetic waves.

According to an aspect of the present invention, OAM modes may be orthogonal to each other and thus, although an OAM mode for an electromagnetic wave and another OAM mode for an electromagnetic wave use an identical frequency and polarization, the OAM mode may be distinct from the other OAM mode. An apparatus for transmitting OAM modes and an apparatus for receiving OAM modes may distinguish a plurality of OAM modes for electromagnetic waves using an identical frequency and polarization. Thus, by implementing transmission and reception multiplexing of wireless communication, a frequency usage efficiency in a super high frequency band may increase.

According to an embodiment of the present invention, a plurality of mode signals having different amplitudes and different phases may be generated by multiplexing input signals, and different OAM modes for electromagnetic waves may be output based on the mode signals using matrix array antenna, whereby the different OAM modes for electromagnetic waves may be simultaneously transmitted and received.

According to an embodiment of the present invention, by demultiplexing mode signals corresponding to received OAM modes for electromagnetic waves, input signals separated for each OAM mode for an electromagnetic wave may be restored.

According to an embodiment of the present invention, by setting OAM modes as independent communication channels, respectively, OAM modes for electromagnetic waves may be distinguished although the OAM modes for electromagnetic waves to be transmitted through the respective communication channels use an identical frequency and polarization. Thus, transmission and reception multiplexing of wireless communication may be implemented, whereby a frequency usage efficiency in a super high frequency band may increase.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for transmitting orbital angular momentum (OAM) modes, the apparatus comprising:
a mode multiplexing apparatus; and
a matrix array antenna configured to output OAM modes for electromagnetic waves based on mode signals,
wherein the mode multiplexing apparatus comprises:
hybrid couplers configured to generate a plurality of output signals having different phases and different amplitudes by mixing and distributing a plurality of input signals; and
phase shifters configured to generate the mode signals by shifting the phases of the output signals.

2. The apparatus of claim 1, wherein the phases and the amplitudes of the output signals are determined based on scattering matrices of the hybrid couplers.

3. The apparatus of claim 1, wherein the mode multiplexing apparatus comprises layers disposed in a hierarchical structure, the layers respectively comprising at least one hybrid coupler and at least one phase shifter.

4. The apparatus of claim 3, wherein phases and amplitudes of the mode signals are determined based on a phase shift value of the at least one phase shifter and a connection structure among the at least one hybrid coupler in each layer.

5. The apparatus of claim 1, wherein the matrix array antenna comprises a plurality of element antennas corresponding to the respective mode signals and arranged in a form of a two-dimensional (2D) matrix.

6. The apparatus of claim 5, wherein the mode multiplexing apparatus is configured to respectively transmit the mode signals to the element antennas using transmission lines corresponding to the element antennas.

7. The apparatus of claim 5, wherein the matrix array antenna is used as a matrix feed configured to output the OAM modes for electromagnetic waves toward a reflecting plate antenna.

8. An apparatus for receiving orbital angular momentum (OAM) modes, the apparatus comprising:
a matrix array antenna configured to output mode signals excited based on OAM modes for electromagnetic waves; and
a mode demultiplexing apparatus configured to restore input signals by mixing the mode signals, distributing the mode signals, and shifting phases of the mode signals,
wherein the mode signals have different phases and different amplitudes for each OAM mode for an electromagnetic wave.

9. The apparatus of claim 8, wherein the mode demultiplexing apparatus comprises:
at least one hybrid coupler configured to generate a plurality of output signals having different phases and different amplitudes by mixing and distributing the plurality of mode signals received from the matrix array antenna; and
at least one phase shifter configured to restore the input signals by shifting the phases of the output signals.

10. The apparatus of claim 8, wherein the mode demultiplexing apparatus comprises layers disposed in a hierarchical structure, the layers respectively comprising at least one hybrid coupler and at least one phase shifter.

11. The apparatus of claim 8, wherein the matrix array antenna comprises a plurality of small antennas corresponding to the respective OAM modes for electromagnetic waves and arranged in a form of a two-dimensional (2D) matrix.

12. A method of transmitting orbital angular momentum (OAM) modes, the method comprising:
generating mode signals by mixing a plurality of input signals, distributing the plurality of input signals, and shifting phases of the plurality of input signals using a mode multiplexing apparatus; and
outputting OAM modes for electromagnetic waves using a matrix array antenna based on the mode signals.

13. The method of claim 12, wherein the generating comprises:
generating a plurality of output signals having different phases and different amplitudes by mixing and distributing the plurality of input signals using hybrid couplers included in the mode multiplexing apparatus; and
generating the mode signals by shifting the phases of the output signals using phase shifters included in the mode multiplexing apparatus.

14. The method of claim 13, wherein the phases and the amplitudes of the output signals are determined based on scattering matrices of the hybrid couplers.

15. The method of claim 12, wherein the mode multiplexing apparatus comprises layers disposed in a hierarchical structure, the layers respectively comprising at least one hybrid coupler and at least one phase shifter.

16. The method of claim 15, wherein phases and amplitudes of the mode signals are determined based on a phase shift value of the at least one phase shifter and a connection structure among the at least one hybrid coupler in each layer.

17. The method of claim 12, wherein the matrix array antenna comprises a plurality of element antennas corresponding to the respective mode signals and arranged in a form of a two-dimensional (2D) matrix.

18. A method of receiving orbital angular momentum (OAM) modes, the method comprising:
outputting mode signals excited based on OAM modes for electromagnetic waves using a matrix array antenna; and
restoring input signals by mixing the mode signals, distributing the mode signals, and shifting phases of the mode signals using a mode demultiplexing apparatus,
wherein the mode signals have different phases and different amplitudes for each OAM mode for an electromagnetic wave.

19. The method of claim 18, wherein the restoring comprises:
generating a plurality of output signals having different phases and different amplitudes by mixing and distributing the plurality of mode signals using hybrid couplers of the mode demultiplexing apparatus; and
restoring the input signals by shifting the phases of the output signals using phase shifters of the mode demultiplexing apparatus.

20. The method of claim 18, wherein the mode demultiplexing apparatus comprises layers disposed in a hierarchical structure, the layers respectively comprising at least one hybrid coupler and at least one phase shifter.
